(19) United States
(12) Patent Application Publication
(10) Pub. No.: US 2013/0250074 A1
(43) Pub. Date: Sep. 26, 2013

(54) APPARATUS, SYSTEM, AND METHOD FOR PROVIDING INDEPENDENT MULTI-SCREEN VIEWING

(71) Applicants: Arther Sing Hook Teng, Bayan Lepas (MY); Nicholas Cheng Hwa Chee, Gelugor (MY); Creyser Yeou Kang Goh, Batu Pahat (MY)

(72) Inventors: Arther Sing Hook Teng, Bayan Lepas (MY); Nicholas Cheng Hwa Chee, Gelugor (MY); Creyser Yeou Kang Goh, Batu Pahat (MY)

(21) Appl. No.: 13/992,681

(22) PCT Filed: Nov. 21, 2011
(86) PCT No.: PCT/US11/61635

§ 371 Date: Jun. 7, 2013

(51) Int. Cl. H04N 13/04

(52) U.S. Cl. CPC H04N 13/044
USPC 348/54

(57) ABSTRACT

Described herein are apparatus, system, and method for providing independent multi-screen viewing of multiple video streams on a digital display. The apparatus comprises a pair of active shutter eye-glasses; a receiver for receiving a first signal corresponding to a first frame from a first video stream being displayed on a display unit; and a processor operable to: darken the pair of eye-glasses during a time interval of a second frame from a second video stream being displayed on the display unit; and make transparent the pair of eye-glasses during a time interval of the first frame. The display unit displays multiple video streams on full screen size, and each user with the apparatus can independently view the full screen sized video and receive its corresponding audio signal.

### CLAIM OF PRIORITY

This application claims the benefit of priority of International Patent Application No. PCT/US2011/061635 filed Nov. 21, 2011, titled “APPARATUS, SYSTEM, AND METHOD FOR PROVIDING INDEPENDENT MULTI-SCREEN VIEWING,” which is incorporated by reference in its entirety.

### BACKGROUND

Current display technologies allow users to view one video channel at a time on full screen size. To view multiple video channels on a single display, the display is split into partitions and each video stream is displayed on a portion of the partitions. Splitting the display takes away from the experience of viewing a video on a full-sized screen display of the video channel.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1 is a display unit that displays multiple video channels by partitioning the display.

FIG. 2 is display unit operable to provide independent multi-screen viewing on two or more pair of eye-glasses, according to one embodiment of the invention.

FIG. 3 is a pair of eye-glasses operable to provide independent multi-screen viewing on a display screen of the display unit, according to one embodiment of the invention.

FIG. 4 is method flowchart performed by the display unit for providing independent multi-screen viewing on the display screen of the display unit for two or more eye-glasses, according to one embodiment of the invention.

FIG. 5 is method flowchart performed by pairs of eye-glasses for providing independent multi-screen viewing on the display screen of the display unit, according to one embodiment of the invention.

FIG. 6A shows interlacing of two frames from two different video streams which are alternated when projected on the display screen of the display unit, according to one embodiment of the invention.

FIG. 6B is a system showing two interlaced frames from two different video streams projected on the display screen and viewed by two or more eye-glasses at full screen sizes, according to one embodiment of the invention.

### SUMMARY

The following presents a simplified summary of the embodiments of the invention in order to provide a basic understanding of some aspects of the embodiments. This summary is not an extensive overview of the embodiments of the invention. It is intended to neither identify key or critical elements of the embodiments nor delineate the scope of the embodiments. Its sole purpose is to present some concepts of the embodiments of the invention in a simplified form as a prelude to the more detailed description that is presented later.

Embodiments of the invention relate to an apparatus, system, and method for providing independent multi-screen viewing of multiple video streams on a digital display. In one embodiment, multiple users wearing their respective eye-glasses are able to view different video streams being displayed in full-size on the display unit.

In one embodiment, the method performed by at least two pair of eye glasses comprises: receiving, on a first pair of eye-glasses, a first signal corresponding to a first frame from a first video stream being displayed on a display screen; receiving, on a second pair of eye-glasses, a second signal corresponding a second frame from a second video stream being displayed on the display screen; darkening the first pair of eye-glasses during a time interval of the second frame from the second video stream; and darkening the second pair of eye-glasses during a time interval of the first frame from the first video stream.

In one embodiment, the method performed by a display unit comprises: displaying a first frame from a first video stream on a display screen; displaying a second frame from a second video on the display screen; transmitting a first signal to darken a first pair of eye-glasses during a time interval of the second frame from the second video stream; and transmitting a second signal to darken a second pair of eye-glasses during a time interval of the first frame from the first video stream.

In one embodiment, the display unit for displaying two or more video streams, comprises: a decoder to decode the two or more video streams including first and second video streams, the decoder to generate a corresponding picture format for displaying; an interlace unit, coupled to the decoder, to: receive the corresponding picture frame, generate a first frame corresponding to the first video stream, and generate a second fame corresponding to the second video stream; a screen to display the first and second frames; and a first transmitter to transmit a first signal for darkening a first pair of eye-glasses during a time interval of the second frame from the second video stream, and to transmit a second signal for darkening the second pair of eye-glasses during a time interval of the first frame from the first video stream.

In one embodiment, apparatus operable for viewing multiple full-sized video stream on a display comprises: a pair of lenses; a receiver for receiving a signal corresponding to a first frame from a first video stream being displayed on a display unit; and a processor to process the signal and to: darken the pair of lenses during a time interval of a second frame from a second video stream being displayed on the display unit; and make transparent the pair of lenses during a time interval of the first frame from the first video stream being displayed on the display unit.

While the summary of the invention has been described in conjunction with specific embodiments thereof, many alternatives, modifications and variations of such embodiments will be apparent to those of ordinary skill in the art in light of the foregoing description.

For example, the users of the pair of eye-glasses can adjust the shutter timing speed of their active shutter lenses so as to change the video streams they were signed up to watch. In one embodiment, the shutter timing of the pair of eye-glasses may be altered so that multiple users are set to watch the same video stream while some users who have different shutter timing are set to watch another video stream. While the embodiments are shown for at least two users who are set to watch different full-sized video streams using the active shutter eye-glasses, the number of users can be three or more without changing the essence of the embodiments of the invention. In one embodiment, the active shutter eye-glasses are enabled to allow the users of the eye-glasses to watch 3D images using alternate-frame sequencing.

The following description and the annexed drawings set forth in detail certain illustrative aspects of the embodiments of the invention. These aspects are indicative, however, of but a few of the various ways in which the principles of the embodiments of the invention may be employed. The embodiments of the invention are intended to embrace all equivalents in the form of alternatives, modifications, and variations that fall within the broad scope of the appended claims. Other advantages and novel features of the embodiments of the invention will become apparent from the following detailed description of the embodiments of the invention when considered in conjunction with the drawings.

### DETAILED DESCRIPTION

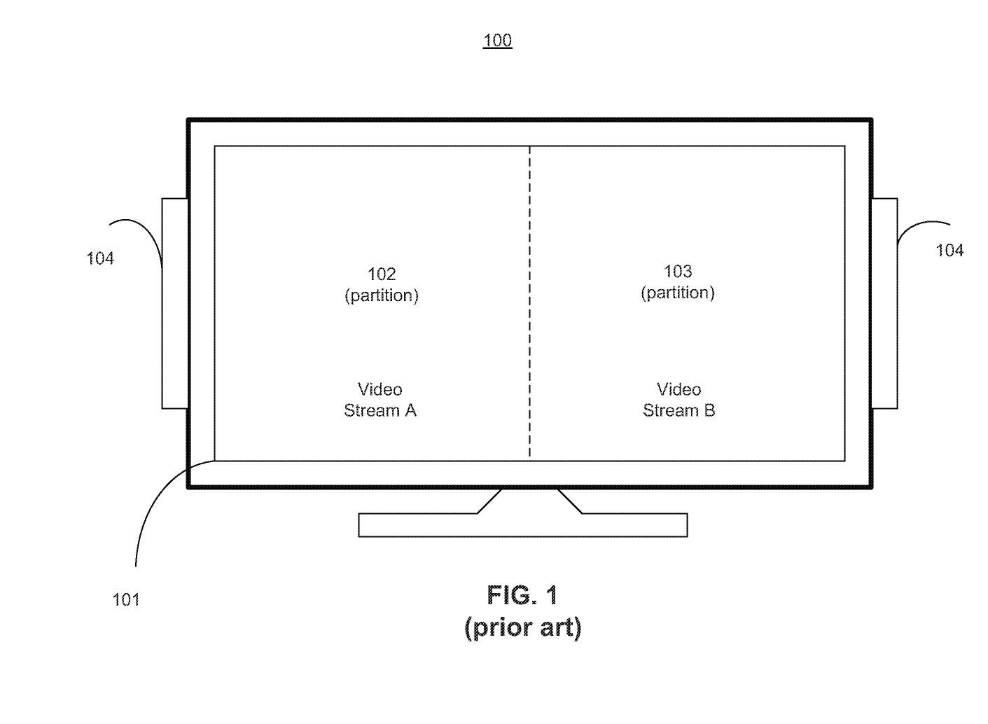

FIG. 1 shows a display unit 100 that displays multiple video channels by partitioning the display. The display unit 100 has a display 101 partitioned into two partitions 102 and 103 to display video stream A and video stream B, respectively. The speakers 104 of the display unit 100 can only output audio associated with one video, either video stream A or video stream B.

Viewing multiple video channels in partitions takes away from the experience of viewing a video on a full-sized screen display of the video channel. Furthermore, multiple users when viewing the display screen can view what each user is viewing. Additionally, only a single audio associated with one of the multiple video channels may be heard on the speakers connected to the display unit. As more than two video channels are displayed on the display, more partitions are generated on the display that reduces the active size of the video channel on the display because the size of the partition is reduced to accommodate viewing of more video channels.

Embodiments of the invention relate to an apparatus, system, and method for providing independent multi-screen viewing of multiple video streams on a digital display. In one embodiment, multiple users wearing their respective eye-glasses are able to view different video streams being displayed in full-size on the display unit. In one embodiment, the eye-glasses are active shutter eye-glasses that are operable to filter a video stream from among several video streams. The term “full-size” herein refers to the active area of a display screen of the display unit on which a frame of a video stream is displayed completely on the entire active area, or almost completely (within 20% of total active area) of the entire active area of the display screen.

The users wear an apparatus (active shutter eye-glasses) which comprises: a pair of lenses; a receiver for receiving a signal corresponding to a first frame from a first video stream being displayed on a display unit; and a processor to process the signal and to: darken the pair of lenses during a time interval of a second frame from a second video stream being displayed on the display unit; and make transparent the pair of lenses during a time interval of the first frame so the user of the apparatus may view the first frame from a first video stream being displayed on the display unit.

In one embodiment, the eye-glasses are operable to execute a method comprising: receiving, on a first pair of eye-glasses, a first signal corresponding to a first frame from a first video stream being displayed on a display unit; receiving, on a second pair of eye-glasses, a second signal corresponding to a second frame from a second video stream being displayed on the display unit; darkening the first pair of eye-glasses during a time interval of the second frame from the second video stream; and darkening the second pair of eye-glasses during a time interval of the first frame from the first video stream.

In one embodiment, the display unit is a digital display unit which is operable to perform a method comprising: displaying a first frame from a first video stream on a display unit; displaying a second frame from a second video stream on the display unit; transmitting a first signal to darken the first pair of eye-glasses during a time interval of the second frame from the second video stream; and transmitting a second signal to darken the second pair of eye-glasses during a time interval of the first frame from the first video stream. The display unit can be a Plasma display, Liquid Crystal Display (LCD), or any other type of digital display unit.

The technical effects of the embodiments herein is that multiple users can independently, i.e. independent from other users, view a full-sized video on a display and receive its corresponding audio. Each user may view its own video and receive its corresponding audio while watching a full screen sized video on the same display unit. In the embodiments discussed herein, the display screen need not be partitioned into smaller screen sizes for users to view their video of interest. The pair of eye-glasses worn by each user can also provide three dimensional (3D) view of the video on the display screen while other users may be watching a 2D video on the same display screen. The above-listed technical effects are not a limiting list. Other technical effects, not listed, are contemplated from the embodiments described herein.

In the following description, numerous details are discussed to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

In the following description and claims, the term “coupled” and its derivatives may be used. The term “coupled” herein refers to two or more elements which are in direct contact (physically, electrically, magnetically, optically, etc.). The term “coupled” herein may also refer to two or more elements that are not in direct contact with each other, but still cooperate or interact with each other.

As used herein, unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

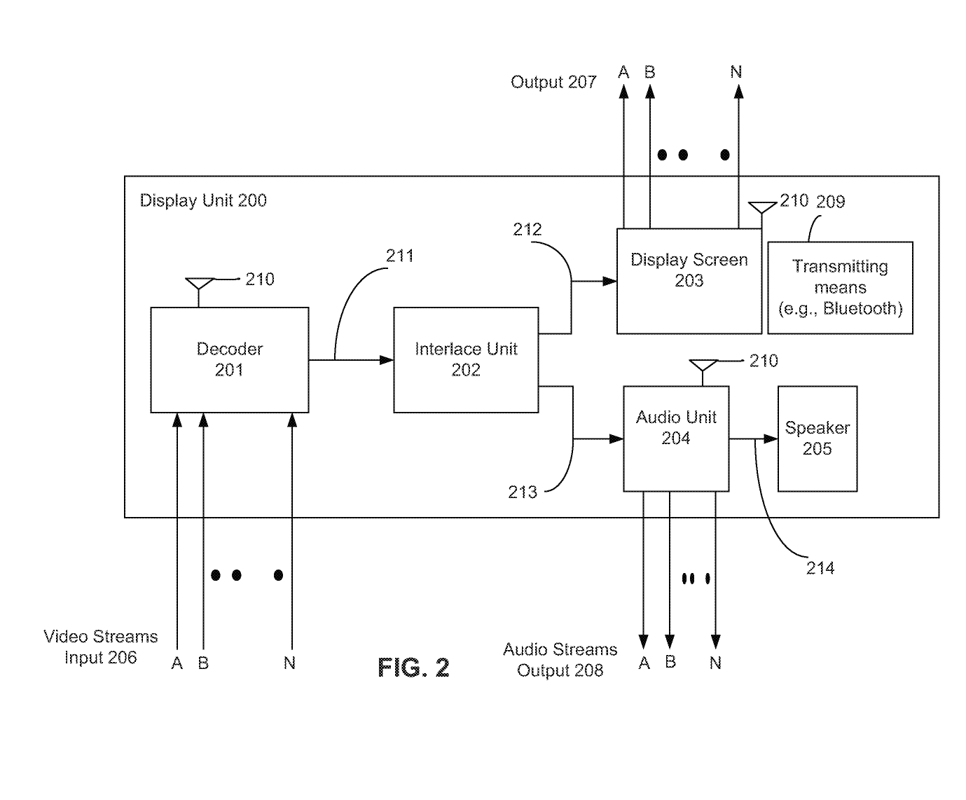

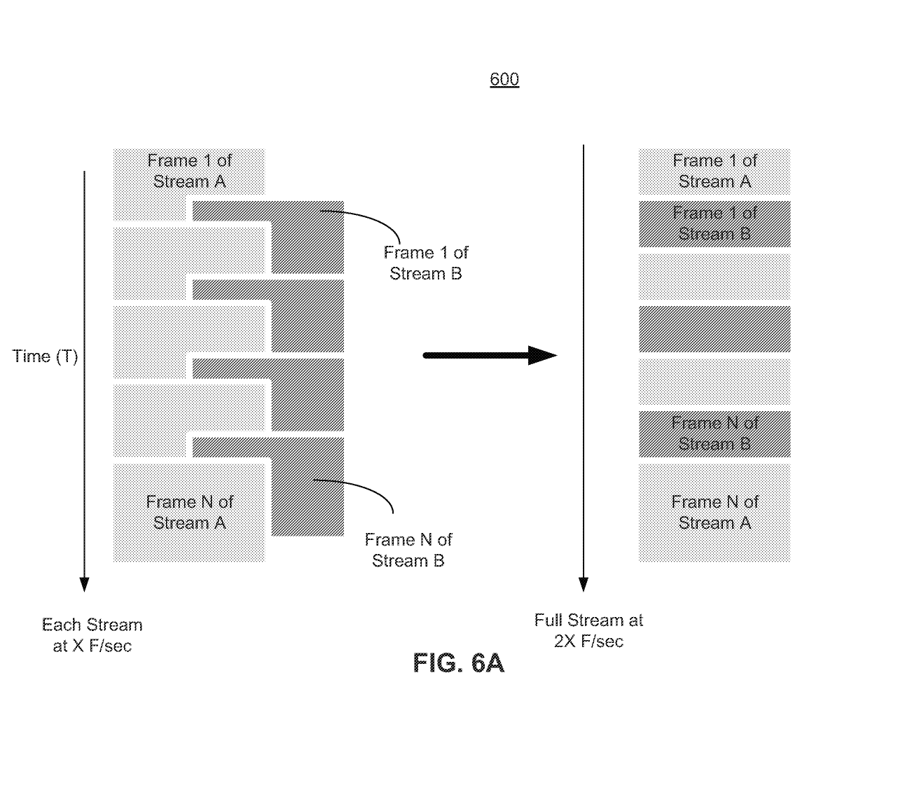

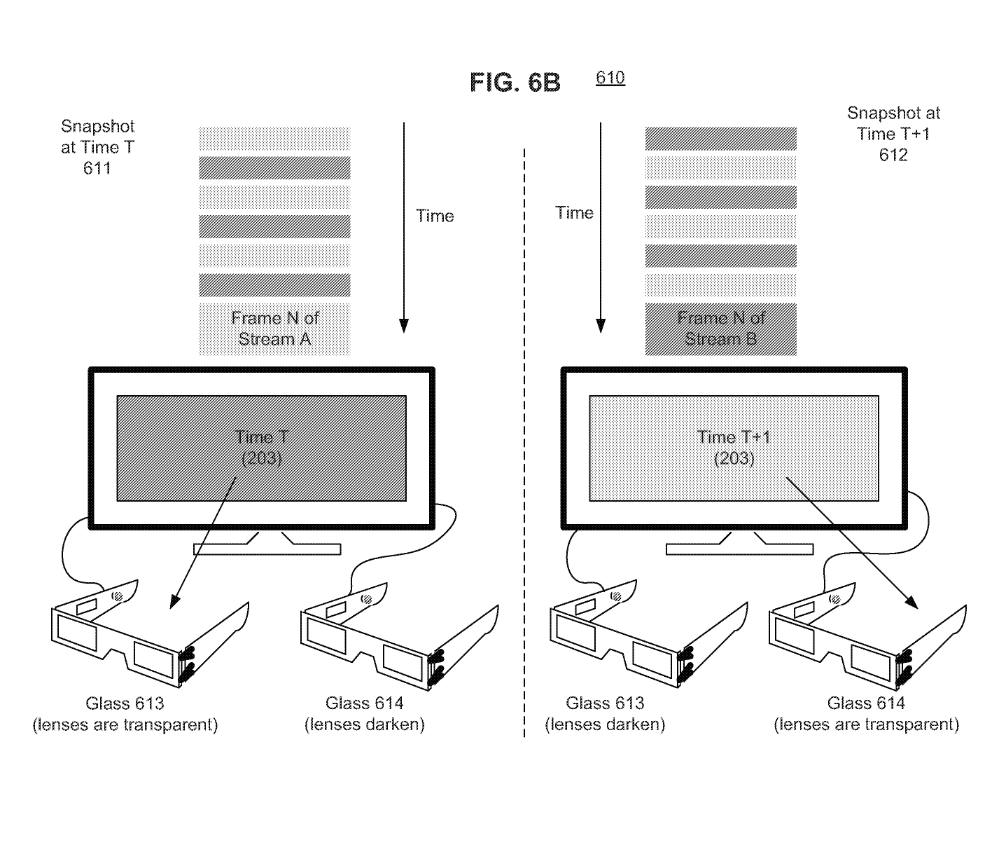

FIG. 2 is display unit 200 operable to provide independent multi-screen viewing (picture and sound) on two or more pair of active shutter eye-glasses, according to one embodiment of the invention. In one embodiment, the display unit 200 comprises a decoder 201 which is operable to receive multiple video streams 206A-N. In one embodiment, some of the video streams may be 3D video streams. In one embodiment, the decoder 201 processes the raw video streams 206 and generates a picture format for each video stream. In one embodiment, the display unit 200 comprises an interlace unit 202 which is operable to receive the picture formats from the decoder 201 and generate interlaced video frames 212 and corresponding audio 213. An example of two interlaced video frames 212 is shown in FIG. 6A.

Referring back to FIG. 2, in one embodiment, the display unit 200 comprises a display screen 203 which is operable to display full-size frames 212 of each video stream on its display 203. In the embodiments discussed herein the display screen 203 is operable to display frames at speeds faster than the frames per second (fps) of the input video streams 206A-N. For example, for two input video streams 206A and B having 30 fps each, the display screen 203 displays the videos at 60 fps, i.e. twice the speed on the two video streams. As the speed of the display screen 203 increases, more videos can be displayed in full-size on the display screen 203 for independent viewing by multiple users.

In one embodiment, the display screen is operable to output signals 207A-N to inform the pair of eye-glasses when to darken and make transparent its lenses. In one embodiment, each output signals 207A-N are transmitted to corresponding pair of eye-glasses by wired or wireless means 210. In one embodiment, each output signal 207A-N informs a corresponding pair of eye-glasses when to darken and make transparent its lenses. In one embodiment, each output signal 207A-N is also capable to inform the pair of eye-glasses that the frame being displayed by the display unit 200 is a 3D video frame. In one embodiment, the display unit 200 includes Bluetooth™ capability to transmit wirelessly signals 207A-N to corresponding pairs of eye-glasses.

In one embodiment, the signals are transmitted to corresponding pair of eye-glasses by wired or wireless means. In one embodiment, the wired or wireless means are implemented by any type of well known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Wi-Fi, HomePlug AV (HPAV), Ultra Wide Band (UWB), Bluetooth, WiMAX, Near Field, or any form of wireless communication protocol.

In one embodiment, the display unit 200 comprises an audio unit 204 coupled to audio speakers 205. In one embodiment, the audio unit 204 is operable to transmit audio stream outputs 208A-N to the users of the pairs of eye-glasses, wherein each audio stream output corresponds to its respective video frame from among the video frames 212. In one embodiment, the display unit 200 includes Bluetooth™ capability (or any other transmission technology as discussed above) to transmit wirelessly (or by wired means) each output audio stream from the streams 208A-N to corresponding pairs of eye-glasses.

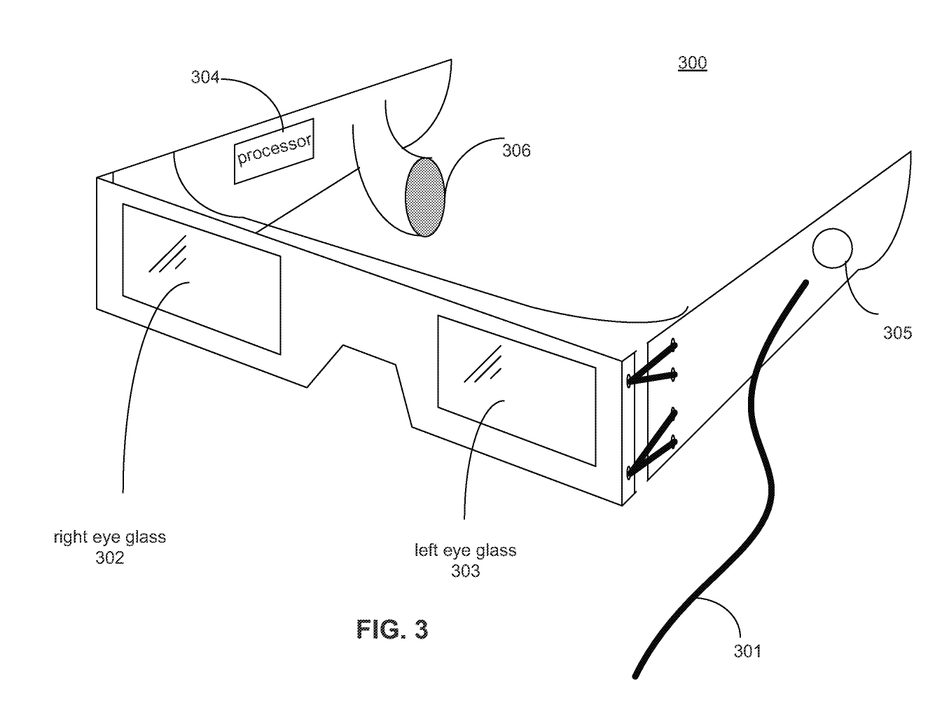

FIG. 3 is a pair of eye-glasses 300 operable to provide independent multi-screen viewing on the display unit 200, according to one embodiment of the invention. FIG. 3 is described with reference to FIG. 2. In one embodiment, the pair of eye-glasses 300 comprises active shutter lenses 302 and 303. Active shutter lenses are also called liquid crystal (LC) shutter glasses. In one embodiment, the pair of eye-glasses 300 is used in conjunction with the display unit 200 and is operable to create the illusion of a 3D image and/or provide an impression to the user of the pair of eye-glasses that the user is watching a video stream on full-size on the display 203 of the display unit 200. In one embodiment, the pair of eye-glasses 300 is operable to apply alternate frame sequencing on its lenses to provide the illusion of a 3D image being displayed on the display screen 203.

In one embodiment, the signal 207 is received directly by wired 301 or wireless means 305 from the display unit 200. In one embodiment, the wired or wireless means are implemented by any type of well known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Wi-Fi, HomePlug AV (HPAV), Ultra Wide Band (UWB), Bluetooth, WiMAX, Near Field, or any form of wireless communication protocol. In one embodiment, the signal 207 is be received by Bluetooth™ communication receiver 305 which communicates with the Bluetooth™ communication transmitter 209 of the display unit 200.

In one embodiment, the pair of eye-glasses 300 includes an integrated processor 304 which is operable to process the signal 207 received from the display unit 200, identify the frequency (fps) of the video signal, and identify whether the video is a 3D video. In one embodiment, each lens 302 and 303 is operable to darken when a voltage is applied to it. Otherwise, the lenses 302 and 303 remain transparent. In one embodiment, the voltage is applied upon receiving instructions from the processor 304 that processes the signal 207 transmitted from the display unit 200.

To provide the illusion, to a user wearing the pair of eye-glasses 300, of a full-sized video being displayed by the display screen 300, the signal 207 received by the pair of eye-glasses from the display unit 200 controls when to darken and make transparent the lenses 302 and 303. In one embodiment, the processor 304 processes the signal 207 received (wirelessly on 305 or by wired means 301) and determines at what frequency both lenses 302 and 303 need to be darkened and when to make both lenses 302 and 303 transparent for viewing the video by the user on the display screen 203. Based on how many videos are being displayed on the display screen 203 for different users wearing their respective pair of eye-glasses, the frequency for darkening the lenses 302 and 303 for each pair of eye-glasses is determined such that the lenses of each pair of eye-glasses, corresponding to each user, darkens when a video frame that the user is not signed up to watch is being displayed on the display screen 203. When the video frame of interest, i.e. of the video stream that the user has signed up to watch, is being displayed on the display screen 203, then the lenses of that pair of eye-glasses is made transparent by an instruction from the processor 304 in response to processing the signal 207.

While the embodiments herein describe a dedicated processor 304 that controls when to darken the lenses 302 and 303 and when to make them transparent, in some embodiments the processing takes place at the display unit 200 and signals indicating when to darken and when to make the lenses 302 and 303 transparent are directly transmitted from the display unit 200 to the respective pair of eye-glasses 300 so they may darken and make lenses transparent at the correct frequencies. In such an embodiment, the display unit 200 knows from prior registration by users of the pair of eye-glasses which pair of eye-glasses should receive which video signal.

While the embodiments of the pair of eye-glasses 300 discuss LC shutter glass technology, other lens technologies may be used that can cause a lens to darken and become transparent at speeds faster than the video stream fps by applying voltage or current to the lens.

In one embodiment, the pair of eye-glasses 300 includes one or two ear pieces 306 to provide audio to the user of the pair of eye-glasses 300, the audio transmitted from the display unit 200. In one embodiment, the audio may be received by wireless means, for example, by Bluetooth™ communication receiver 305 which communicates with the Bluetooth™ communication transmitter 209 of the display unit 200. In other embodiments, other technologies (as discussed above) for wired or wireless communication may be used for transmitting and receiving the audio signals. While the embodiment of FIG. 3 shows an integrated ear piece 306 for transmitting audio to the user, the ear piece can be separate from the pair of eye-glasses without changing the essence of the embodiments of the invention.

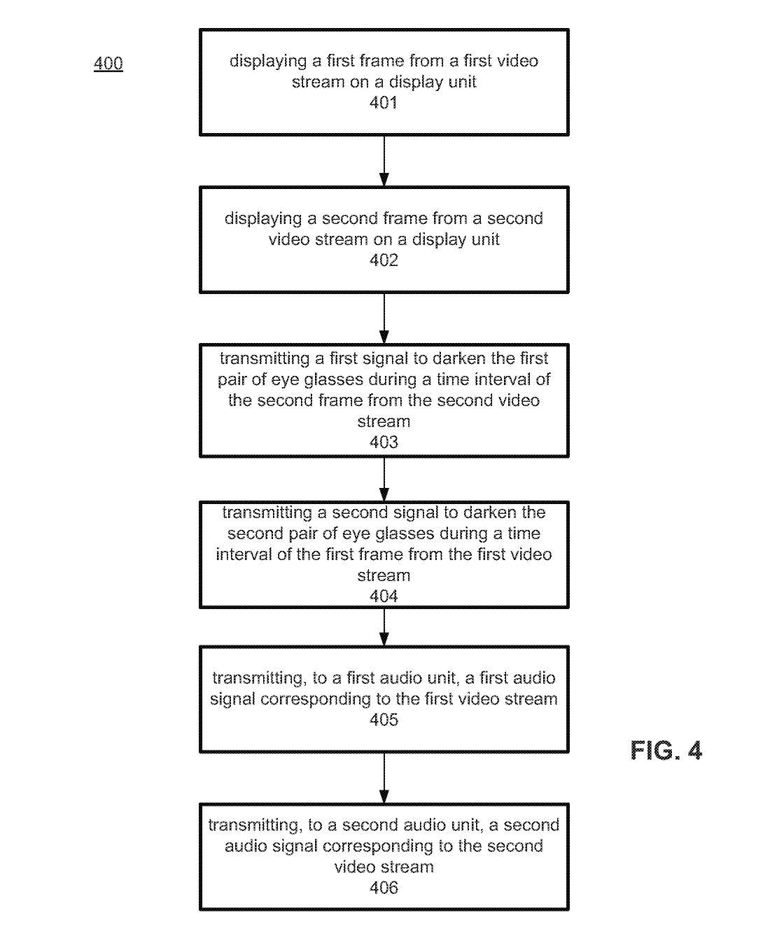

FIG. 4 is method flowchart 400 performed by the display unit 200 for providing independent multi-screen viewing on the display screen 203 for two or more active shutter eye-glasses (e.g., pair of eye-glasses 300), according to one embodiment of the invention. Although the blocks in the flowchart 400 are shown in a particular order, the order of the actions can be modified. Thus, the illustrated embodiments can be performed in a different order, and some actions/blocks may be performed in parallel. Additionally, one or more actions/blocks can be omitted in various embodiments of providing independent multi-screen viewing on the display unit for two or more active eye-glasses. The flowchart of FIG. 4 is illustrated with reference to the embodiments of FIG. 2-3.

The following method flowchart is illustrated for two video streams being shown on full screen size on the display screen 203. The method can be extended to two or more video streams being displayed on the display screen 203, and for two or more users wearing their respective pair of eye-glasses (e.g., pair of eye-glasses 300).

At block 401, the display unit 200 displays a first frame from a first video stream (e.g., video stream 206A) on a display screen 203. At block 402, the display unit 200 displays a second frame from a second video stream (e.g., 206B) on the display screen 203. At block 403, the display unit 200 transmits a first signal (e.g., 207A) to darken the first pair of eye-glasses, i.e. darken the lenses 302 and 303, during a time interval of the second frame from the second video stream. At block 404, the display unit 200 transmits a second signal (e.g., 207B) to darken the second pair of eye-glasses, i.e. darken the lenses 302 and 303, during a time interval of the first frame from the first video stream.

At block 405, the display unit 200 transmits, to a first audio unit (e.g., 306 of FIG. 3) coupled to the first pair of eye-glasses, a first audio signal (e.g., 208A) corresponding to the first video stream (e.g., 206A). At block 406, the display unit transmits, to a second audio unit coupled to the second pair of eye-glasses, a second audio signal (e.g., 208B) corresponding to the second video stream (e.g., 206B).

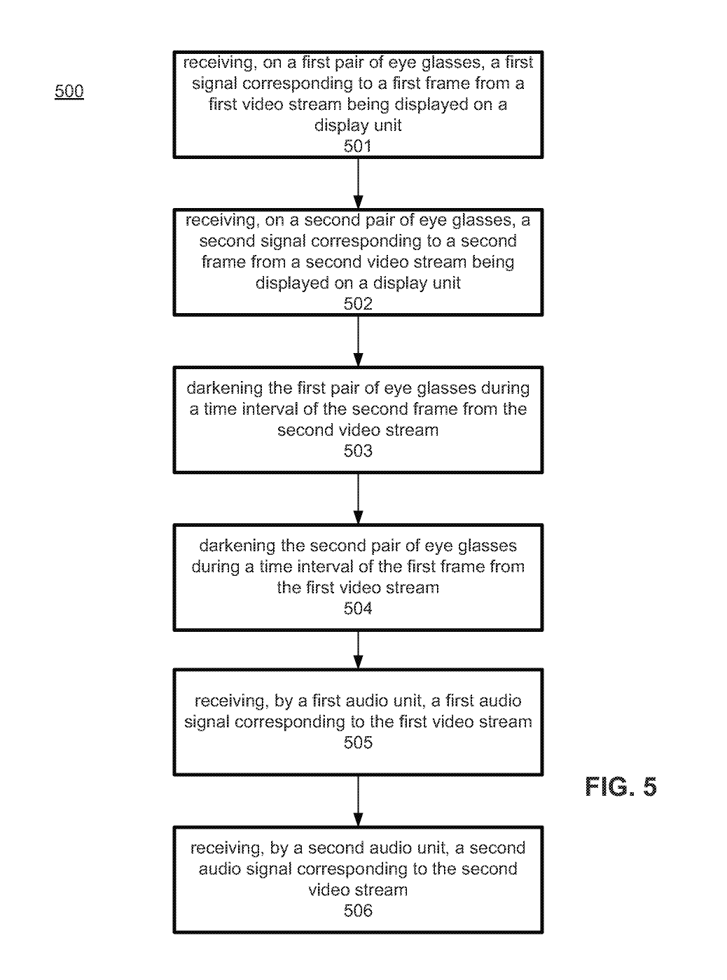

FIG. 5 is method flowchart 500 performed by pairs of eye-glasses (e.g., pair of eye-glasses 300) for providing independent multi-screen viewing on the display screen 203, according to one embodiment of the invention. Although the blocks in the flowchart 500 are shown in a particular order, the order of the actions can be modified. Thus, the illustrated embodiments can be performed in a different order, and some actions/blocks may be performed in parallel. Additionally, one or more actions/blocks can be omitted in various embodiments of providing independent multi-screen viewing on the display unit for two or more active eye-glasses. The flowchart of FIG. 5 is illustrated with reference to the embodiments of FIG. 2-3.

The following method flowchart is illustrated for two video streams being shown on full screen size on the display screen 203. The method can be extended to two or more video streams being displayed on the display screen 203, and for two or more users wearing their respective eye-glasses (e.g., eye-glasses 300).

At block 501, a first pair of eye-glasses (e.g., pair of eye-glasses 300) receives a signal (e.g., 207A) corresponding to a first frame from a first video stream (e.g., video stream 206A) being displayed on a display screen 203. At block 502, a second pair of eye-glasses (e.g., another pair of eye-glasses 300) receives another signal (e.g., 207B) corresponding a second frame from a second video stream being displayed on the display screen 203. At block 503, the processor 304 in the first pair of eye-glasses processes the signal 207 (e.g., 207A) from the display unit 200 and determines when to darken the first pair of eye-glasses, i.e. darken the lenses 302 and 303, during a time interval of the second frame from the second video stream (e.g., 206B). During this time interval, the processor 304 causes the second pair of eye-glasses to become transparent, i.e. to make lenses 302 and 303 transparent, and allowing the user of the second pair of eye-glasses to view the video it signed up to view.

At block 504, the processor 304 in the second pair of eye-glasses processes the signal 207 (e.g., 207B) from the display unit 200 and determines when to darken the second pair of eye-glasses, i.e. darken the lenses 302 and 303, during a time interval of the first frame from the first video stream (e.g., 206A). During this time interval, the processor 304 causes the first pair of eye-glasses to become transparent, i.e. to make transparent the lenses 302 and 303, and allowing the user of the first pair of eye-glasses to view the video it signed up to view.

At block 505, a first audio unit (e.g., ear piece 306 of FIG. 3) coupled to the first pair of eye-glasses receives a first audio signal (e.g., signal 208A) corresponding to the first video stream (e.g., signal 206A). At block 506, second audio unit (e.g., ear piece 306 of another pair of eye-glasses 300) coupled to the second pair of eye-glasses receives a second audio signal (e.g., signal 208B) corresponding to the second video stream (e.g., signal 206B).

FIG. 6A is a timing diagram 600 illustrating interlacing of two frames from two different video Streams A and B which are alternated when projected on the display screen 203, according to one embodiment of the invention. So as not to obscure the embodiments of the invention, FIG. 6A shows two frames, Frames 1 and 2 of Streams A and B, being interlaced. However, any number of frames can be interlaced according to the embodiments discussed herein. For example, if a display screen 203 is capable of displaying 4 times the frames per second than the frames per second of each video stream, then four frames (A-D) can be interlaced and then serialized for display.

The frames in FIG. 6A belong to two different video streams shown by the shaded contrast. The frames on the left side illustrate how the interlace unit 202 interlaces a series of picture formats 211. The frames on the right side are the serialized frames being displayed serially on the display screen 203. In this example, Frame 1 of video Stream A is first displayed on the display screen 203 followed by Frame 1 of video Stream B. As discussed above, when Frame 1 of video Stream A is displayed on the display screen 203, the lenses 302 and 303 of the pair of eye-glasses (e.g., eye-glasses 300) of the user who signed up to watch video Stream A (e.g., 206A) are made transparent for the time interval Frame 1 of video Stream A is displayed on the display screen 203. During this time interval, the display unit 200 transmits a signal (e.g., signal 207B) to the second user wearing its respective pair of eye-glasses to darken the lenses 302 and 303 of its pair of eye-glasses so that the second user may filter out Frame 1 of video Stream A.

The speed of displaying the frames is fast enough for a user to view the video stream, which the user has signed up to watch, without any break in continuity in viewing the video. This allows multiple users to view on full screen size their respective video streams in a continuous fashion using their personal pair of active shutter eye-glasses.

FIG. 6B is a system 610 showing two interlaced frames from two different video streams projected on the display screen 203 and viewed on for two or more active shutter eye-glasses (e.g., eye-glasses 300) at full screen sizes, according to one embodiment of the invention. FIG. 6B is described with reference to FIGS. 2-5 and FIG. 6A. The snapshots 611 and 612 are snapshots of frames of two different video streams, Stream A and Stream B, in a pipeline to be projected on the display screen 203 at time intervals ‘T’ and ‘T+1’ respectively. The dark shaded frames correspond to video Stream B while the light shaded frames correspond to video Stream A.

At snapshot 611, the processor 304 in the pair of eye-glasses 613 (e.g., pair of eye-glasses 300) of the user who signed up for viewing video Stream B will instruct its lenses to become transparent so the user with pair of eye-glasses 613 may watch the video Stream B on the display screen 203. During this time ‘T,’ the processor 304 pair of eye-glasses 614 (e.g., pair of eye-glasses 300) of the user who signed up for viewing video Stream A will instruct its lenses to darken to filter out video Stream B so the user may not watch video Stream A on display screen 203.

At snapshot 612, the processor 304 pair of eye-glasses 614 (e.g., pair of eye-glasses 300) of the user who signed up for viewing video Stream A will instruct its lenses to become transparent so the user with the pair of eye-glasses 613 may watch video Stream A on the display screen 203. During this time interval ‘T+1,’ the processor 304 pair of eye-glasses 613 (e.g., pair of eye-glasses 300) of the user who signed up for viewing video Stream B will instruct its lenses to darken to filter video Stream A so the user may not watch video Stream A on the display screen 203 (because the display screen 203 is displaying Stream B which the user has not signed up to watch).

Each user receives its corresponding audio signals, i.e., at snapshot ‘T,’ the user of pair of eye-glasses 613 will receive audio corresponding to video Stream B during time ‘T’ while user of eye-glasses 614 will not receive the audio corresponding to video Stream B during time ‘T.’ Likewise, at snapshot ‘T+1,’ the user of pairs of eye-glasses 614 will receive audio corresponding to video Stream A during time T+1’ while user of eye-glasses 613 will not receive the audio corresponding to video Stream A during time ‘T+1.’

Elements of embodiments are also provided as a machine-readable medium for storing the computer-executable instructions (e.g., instructions to implement the flowcharts of FIG. 4 and FIG. 5, and other processes discussed). The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic or computer-executable instructions. For example, embodiments of the invention may be downloaded as a computer program (e.g., BIOS) which may be transferred from a remote computer (e.g., a server) to a requesting computer (e.g., a client) by way of data signals via a communication link (e.g., a modem or network connection).

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

While the invention has been described in conjunction with specific embodiments thereof, many alternatives, modifications and variations of such embodiments will be apparent to those of ordinary skill in the art in light of the foregoing description.

For example, the users of the pair of eye-glasses (e.g., eye-glasses 300) can adjust the shutter timing speed of their active shutter lenses so as to change the video streams they were signed up to watch. In one embodiment, the shutter timing of the pair of eye-glasses may be altered so that multiple users are set to watch the same video stream while some users who have different shutter timing are set to watch another video stream. While the embodiments are shown for at least two users who are set to watch different full-sized video streams using the active shutter eye-glasses, the number of users can be three or more without changing the essence of the embodiments of the invention. In one embodiment, the active shutter eye-glasses (e.g., eye-glasses 300) are enabled to allow the users of the eye-glasses to watch 3D images using alternate-frame sequencing.

The embodiments of the invention are intended to embrace all such alternatives, modifications, and variations as to fall within the broad scope of the appended claims.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. A method comprising:
receiving, on a first pair of eye-glasses, a first signal corresponding to a first frame from a first video stream being displayed on a display screen;
receiving, on a second pair of eye-glasses, a second signal corresponding a second frame from a second video stream being displayed on the display screen;
darkening the first pair of eye-glasses during a time interval of the second frame from the second video stream; and
darkening the second pair of eye-glasses during a time interval of the first frame from the first video stream.

2. The method of claim 1, wherein the first and second video streams being displayed in full screen size on the same display screen.

3. The method of claim 1 further comprises:
receiving, by a first audio unit coupled to the first pair of eye-glasses, a first audio signal corresponding to the first video stream; and
receiving, by a second audio unit coupled to the second pair of eye-glasses, a second audio signal corresponding to the second video stream.

4. The method of claim 3, wherein the first and second audio units are operable to receive first and second audio signals by wireless means.

5. The method of claim 1, wherein the display screen is operable to display the first and second video streams at frames per second at least twice as fast as frames per second of the first and second video streams.

6. The method of claim 1, wherein the first and second pair of eye-glasses are active shutter glasses.

7. The method of claim 1, wherein the first and second pairs of eye-glasses are operable to apply alternate frame sequencing on each pair of glasses to provide a three dimensional effect to users of the first or second pairs of eye-glasses.

8. A method comprising:
displaying a first frame from a first video stream on a display screen;
displaying a second frame from a second video on the display screen;
transmitting a first signal to darken a first pair of eye-glasses during a time interval of the second frame from the second video stream; and
transmitting a second signal to darken a second pair of eye-glasses during a time interval of the first frame from the first video stream.

9. The method of claim 8 further comprises:
displaying, in full screen size, on the display screen the first and second video streams,
wherein the display screen is operable to display the first and second video streams at frames per second at least twice as fast as frames per second of the first and second video streams.

10. The method of claim 8 further comprises:
receiving two more video stream including the first and second video streams to be displayed as interlaced frames on the display screen.

11. The method of claim 8 further comprises:
transmitting, to a first audio unit coupled to the first pair of eye-glasses, a first audio signal corresponding to the first video stream; and
transmitting, to a second audio unit coupled to the second pair of eye-glasses, a second audio signal corresponding to the second video stream.

12. The method of claim 8, wherein the first and second pair of eye-glasses are active shutter glasses.

13. The method of claim 8, wherein the first and second pairs of eye-glasses are operable to apply alternate frame sequencing on each pair of glasses to provide a three dimensional effect to users of the first and second pairs of eye-glasses.

14. A display unit for displaying two or more video streams, the display unit comprising:
a decoder to decode the two or more video streams including first and second video streams, the decoder to generate a corresponding picture format for displaying;
an interlace unit, coupled to the decoder, to: receive the corresponding picture frame, generate a first frame corresponding to the first video stream, and generate a second frame corresponding to the second video stream;
a screen to display the first and second frames; and
a first transmitter to transmit a first signal for darkening a first pair of eye-glasses during a time interval of the second frame from the second video stream, and to transmit a second signal for darkening the second pair of eye-glasses during a time interval of the first frame from the first video stream.

15. The display unit of claim 14, wherein the screen is operable to display the first and second frames at frames per second twice as fast as frames per second corresponding to the first and second frames of the first and second video streams.

16. The display unit of claim 14, wherein the screen is operable to display the first and second frames of the first and second video streams in full screen size.

17. The display unit of claim 14 further comprises:
a second transmitter to:
transmit, to a first audio unit coupled to the first pair of eye-glasses, a first audio signal corresponding to the first frame of the first video stream; and
transmit, to a second audio unit coupled to the second pair of eye-glasses, a second audio signal corresponding to the second frame of the second video stream.

18. The display unit of claim 14, wherein the first and second pair of eye-glasses are active shutter glasses.

19. An apparatus comprising:
a pair of lenses;
a receiver for receiving a signal corresponding to a first frame from a first video stream being displayed on a display unit; and
a processor to process the signal and to:
darken the pair of lenses during a time interval of a second frame from a second video stream being displayed on the display unit; and
make transparent the pair of lenses during a time interval of the first frame from the first video stream being displayed on the display unit.

20. The apparatus claim 19, wherein the first and second video streams are being displayed in full screen size on the same display unit.

21. The apparatus of claim 19 further comprises:
an audio unit to receive a first audio signal corresponding to the first video stream.

22. The apparatus of claim 21, wherein the audio unit is operable to receive the first audio signal by wireless means.

23. The apparatus of claim 19, wherein the display unit is operable to display the first and second video streams at frames per second at least twice as fast as frames per second of the first and second video streams.

24. The apparatus of claim 19, wherein the pair of lenses are active shutter glasses.

25. The apparatus of claim 19, wherein the pair of lenses comprises a left hand lens and a right hand lens for viewing respectively by left and right eyes of a user, the pair of lenses operable to apply alternate frame sequencing on the left hand lens and the right hand lens to provide a three dimensional effect of the video stream being displayed on the display unit.
